(19) United States
(12) Patent Application Publication
(10) Pub. No.: US 2006/0024344 A1
(43) Pub. Date: Feb. 2, 2006

(54) Capsicum shark repellent

(76) Inventors: Gonzalo Romero Matos, Saint Petersburg, FL (US); Felix Eduardo Romero, Palm Harbor, FL (US)

Correspondence Address: GONZALO ROMERO M;APT #2, 455 39TH AVE N, SAINT PETERSBURG, FL, 33703-6118, US

(21) Appl. No.: 11/179,118

(22) Filed: Jul. 12, 2005

Related U.S. Application Data
(60) Provisional application No. 60/587,222, filed on Jul. 12, 2004.

(51) Int. Cl. A01N 65/00; A01N 25/00

(52) U.S. Cl. 424/405; 424/760

(57) ABSTRACT

This invention claims a use of Capsicum and Oleoresin capsicum (OC) as a chemical shark repellent. Alkyl chain , antioxidant phenolic group, and pungency properties of capsaicin contained in OC can exert a hostile reaction on lipit membrane of gills and on nonmedullated fibre nerves of body surface of sharks, herein is provided different ways to deter sharks maintaining a high concentration of OC or Capsicum close and safe to the swimmer and scuba diver, permitting it a maximum deterrent force against sharks, It is also suitable as a coating by using paint for rescue operations devices such as the Johnson shark screen and the infant flotation device. Also this invention is proposed a use of a device for delivering a rapid squirt or atomized blast of OC to repel sharks.

### CROSS-REFERENCE TO RELATED APPLICATIONS

This application is entitled to the benefit of Provisional patent application Ser. No. 60/587,222 filed 2004 Jul. 12. Otherwise, omit this section.

### BACKGROUND OF THE INVENTION

1. Field of the Invention

The present invention belongs to chemical deterrents against sharks and other dangerous marine creatures sensitive to Oleoresin capsicum.

2. Prior Art

Pepper has been used during the past as a weapon in asian countries. Chinese and japanese burned and utilized ground pepper against their adversaries, thus, suffocating and temporarily blinding them.

According to Duke (N.D) on the san blas islands off panama, native kuna indians string chili peppers behind thier seagoing dugouts and shark repellents (Andrews, 1984, p. 79). This custom of pre-columbian tribes of panama apparently has a fundamental basis. Sharks in reality can attack boats. Budker (1971), p. 121, mention that mako sharks in particular, seem to be addicted to this type of aggressiveness. It is also known in the tiger shark and the whale shark. On this kind of behavior the shark research panel used a category about boat attacks during the maintenance of the international shark attack file.

Oleoresin capsicum (OC), an active ingredient in pepper spray, was approved by the U.S. Government as a repelling weapon and has been used to control violent individuals through inhalation and skin contact. The canadian plice research centre in 1994 evaluated three products of pepper spray: first defense, cap-stun and punch II, confirming that OC is an effective alternative to the use of leathal force. In releation to this type of product the U.S. Pat. No. 5,217,708 of Pinkney (1993) provides a capsicum containing lachrymator to control humand and animals.

Capsaicin as a main active principle of OC has been disclosed and taken as a reference in this invention in agreement to Buck et al. (1986), like 8-methyl-n-vanillyl-6-nonenamide, IN The neuropharmacology of capsaicin: review of some recent observations, p. 180. The substance is also known as (E)-N [(4-hydroxy-3-methoxyphenyl)-methyl]-8-methyl-6-nonenamide, according to U.S. Pat. No. 4,536,404, Bernstein (1985), Method and composition for treating post-herpetic neuralgia, p. 2, col 2. Capsaicin has also been identified as N-(3-methoxy-4-hydroxybenzyl)-8-methylnon-trans-6-enamide, by Monsereenusorn et al. (1982) IN Capsaicin-a literature survey, p. 322. Likewise in U.S. Pat. No. 6,063,381 OF Staggs (2000), Therapeutic uses of pungent botanicals and their related compounds, capsaicin is also named as (N-[(4-hydroxy-3-methoxyphenyl) methyl] 8-methyl-6-nonenamide) p. 10, col 17.

Synthetic capsaicin has been named as N-vanillylnonanamide by U.S. Pat. No. 5,461,075 O'Neill et al. (1995), Use of vanilloids for the prevention of lesions due to Herpes simplex infections, p. 7, col 9. It has also been referenced by U.S. Pat. No. 5,431,914, Adekunle et al. (1995), AS nonivamide (N-[(4-hydroxy-3-methoxyphenyl)-methyl] nonanamide), in the method of treating an internal condition by external application of capsaicin without the need for systemic absorption, p. 3, col 3.

The U.S. Pat. No. 6,063,381, of Staggs (2000), p. 10, col 17, also defined pharmaceutical compositions of four (4) natural derivatives of capsaicin. they are: dihydrocapsaicin (N-[(4-hydroxy-3-methoxyphenyl) methyl]-8-methylnonanamide); nordihydrocapsaicin (N-[(4-hydroxy-3-methoxyphenyl) methyl]-7-methyloctanamide); homocapsaicin (N-[(4-hydroxy-3-methoxyphenyl) methyl]-9-methyl-7-decenamide); and homodihydrocapsaicin (N-[(4-hydroxy-3-methoxyphenyl) methyl]-9-methyldecanamide. chemical structures of capsaicinoids can be seen if FIGS. 1A, 1B, 1C, 1D AND 1E.

OC and Capsaicin have wisely been used to deter a wide variety of animals. Dogs are deterred by using products such as: halt, mace, dog gone. They are temporarily painful but medically safe. Capsaicin has been used against wolves and coyotes. Likewise, powdered chili peppers to discourage squirrels, armadillos and cats (Andrews, 1984, pp. 78-79). Bears are repelled with products containing OC as a counter assault. It has been used by federal and state wildlife agencies throughout the U.S. as a nonlethal and nontoxic bear deterrent. OC showed its potential as rodent repellent in direct seeding longleaf pine according to U.S. Department of Agriculture, more specifically the forest service Southern Research Station. In addition, OC demonstrated its property as elephant repellent in field trial in the communal lands of Zimbabwe (Osborne, 2002).

The U.S. patent application No. 20030056436 of Neumann (2002), Capsicum based seed coating and method of use, describes a method for preventing destruction of crop seeds by insects using an aqueous formulation of capsicum. moreover the U.S. Pat. No. 5,599,803 OF Hainrihar et al. (1997) titled, Synergistic insecticidal compositions comprising capsicum and insecticidal use thereof, define the repellent effects of capsicum against numerous insect species.

The U.S. Pat. No. 5,226,380 of Fischer (1993), titled, marine organism repellent covering for protection of underwater objects and method of applying same, utilizes OC mixed with paint to repel marine organisms such as zebra mussels and barnacles for boat hulls and submerged pipes.

Since shark meshing was introduced in 1937 until the present time there have been several devices designed to deter sharks. Many of them ahve shown more or less effectiveness. Shark gun, weapon and projectiles, repellent patches, protector suits, electric field deterrents and electronic devices using ultrasound techniques, are some of them.

One such device showing relevant characteristics is called shark screen. Being patented by Clarence S. Johnson (1976) under U.S. Pat. No. 3,986,220, it is believed to be of great value deterring sharks in rescue operations. Likewise lifeboats, flotation bags and an infant flotation device (IFD) developed by the federal aviation in conjunction with the U.S. divers co (Gilbert, 1973, p. 76), are improved with an OC coating. Therefore they have special interest in this invention.

The first concentrated effort to obtain a chemical shark repellent was made in 1942 by the office of naval research during World War II. After evaluation of numerous agents copper acetate and nigrosine were chosen. It became known as shark chaser, nevertheless copper acetate demonstrated a reduced effectivity as a deterrent in the conditions of a feeding frenzy (Brown T. W, 1973. pp. 7-10).

According to Hiatt et al. (1953), pp. 41-42, and after evaluation of 87 selected compounds, they concluded that substances perceived as odors and tastes for humans do not arouse sensations capable of dispersing fish in schoold, but general irritants, lachrymators and nerve poisons may be capable of doing so. General skin irritants such as, phenol, allyl isothiocyanate strongly stimulated the entire body. Lachrymators such as, phenacyl chloride, phenacyl bromide seriously irritated the eyes and impaired vision. Some general nerve poisons such as isobornyl thiocyanoacetate, ethyl mercaptan induced tetanic paralysis. Whereas another such as thiocyanic acid 5,5,5-trichloro amyl ester resulted in flaccid paralysis; and respiratory impairment was brought about by a reducing agent, sodium bisulfite and by probable respiratory poisons such as sodium cyanide, thiocyanic acid 5,5,5-trichloro amyl ester.

Clark (1974), in the article of the National Geographic Magazine the read sea's sharkproof fish, showed a remarkable effect to repel sharks with a toxic peptide secreted from Pardachirus marmoratus. This milky poison expelled by glands along the dorsal and anal fins of this fish was called paradaxin.

Additionally other ichthytoxins such as pavoninins from Pardachirus pavoninus, a relative of the P. mamoratus, were studied by by Tachibana et al. (1984), and showed similar repelling conditons to paradaxin. Likewise as pardaxin another peptide named mosesin-4 was synthesized. It is a naturally ocurring steroid saponin. It shows shark repellent activity (Gargiulo et al., 1989).

Although pardaxin is an effective shark repellent its practical use is limited to that, it is very difficult to synthesize and owns unstable characteristics. In addition, secretion of paradaxin experts lethal aciton on fishes which must not be objective of a shark repellent.

Holothurin, a toxic principle fo the Bahamian holothuria (Actinopyga agassizi) was proposed as a shark repellent. Nevertheless, Holothurin is highly that is highly lethal for fishes and other animal, which has been shown by obotka (1965), p. 583. This saponin of the sea cucumber kills A 50 pound shark in a dilution 1:600.000 wtihin 50 mins.

All those ichthyotoxic peptides are not recommended as deterrents because they exhibit lethal actions against aquatic organisms instead ofF exerting repelling properties .

After tje discovery of pardaxin and relative peptides there were researches developed about other surfactanfs (Gruber et al., 1982, Sisneros et al., 2001). Surfactants were shown to be more effective than pardaxin.

The U.S. patent application No. 20020022045 of Schneider (2002), titled, shark deterrents, provides a chemicla conglomerate to discourage shark attacks or attacks by other sea creatures. Ingredients of this conglomerate, sodium lauryl sulphate and sodium sulphate, are coated to dissolve these active principles over long periods of time.

Ichthyotoxins peptides such as pardaxin showed to be more effective than copper acetate. Likewise, new surfactants demonstrated better properties to repel sharks than pardaxin and relative peptides. Actually, pungent agents such as capsaicin can exert a stronger deterrent action against sharks and other dangerous marine creatures than former surfactants.

Although here, has been comparisons made between former shark repellents and oc, it is recognized in this invention that a chemical deterrent does not work alone by itself without a device constructed to repel sharks in certain and determined circumstances.

According to the opinion of the mote marine laboratory former shark chemical repellents have failed because, their efficacy in at sea situations is minimal due to the rapid dilution of the chemicals in seawater as well as variabilities in individual shark behavior in response to such chemicals.

In this invention proposed is a shark screen, coated with a chemical repellent, which 100% of the substance is not diluted in seawater. by this way, deterrent properties of the chemical are held to the bag, at a maximal concentration, avoiding shark attacks. actually it is recognized by scientific experts that capsaicin and OC are able to generate an effect throughout the animal kingdom, no exception for determined marine and terrestrial species and its variabilities.

### OBJECTIVES

1. Provide devices containing a chemical shark repellent to protect swimmers and divers.
2. Improve the shark screen and other rescue operation devices against sharks and other dangerous aquatic animals.

### SUMMARY

This invention provides a chemical shark repellent containing oleoresin capsicum (oc), which it shows remarkable characteristics to deter sharks and other dangerous fishes. Herein are provided two alternative devices where high concentration of OC is maintained safe and close to the swimmer and scuba diver. It allows a disclosure of a maximum deterrent force against sharks. Also designed is an embodiment to improve devices used in rescue operations such as the shark screen and the infant flotation device. The aforesaid improvement comprises a coating manufactured with paint and oc.

### BRIEF DESCRIPTION OF DRAWINGS

FIG. 1A chemical structure of capsaicin

FIG. 1B chemical structure of norhydrocapsaicin

FIG. 1C chemical structure of dihydrocapsaicin

FIG. 1D chemical structure of homocapsaicin

FIG. 1E chemical structure of homodihydrocapsaicin

FIG. 2 fundamental parts of capsaicin molecular structure

FIG. 3 oleoresin capsicum shark repellent device

FIG. 4 improved shark screen

### REFERENCE NUMBERS OF DRAWINGS

10 acyl-amide link of capsaicin
11 alkyl chain of capsaicin
12 aromatic ring or phenolic group
13 plastic transparent cylinder
14 cap
15 alined holes from the top to the bottom
16 solid plastic screen
17 sponge
18 plastic belt
19 velcro
20 plastic tie
21 annular collar
22 short sleeve
23 drawstring
24 sheet of the shark screen
25 antishark OC coating
26 aluminizing layer
27 body heat
28 reflected light
29 valve
30 heat and pungency effect of oc

### DETAILED DESCRIPTION

OC is an oily extract of hot peppers that is used in foods, pharmaceuticals and increasingly in law enforcement applications. OC is also called african capsicum oleoresin. It is prepared from the most pungent chillies grown in africa and some other countries. Additionally, other extracts are also prepared from dried fruits of the capsicum species, they are oleoresin red pepper and oleoresin paprika. These latter extracts have a lesser degree of pungency than oc.

The hot sensation or pungency of oleoresin extracts is quantified in the industry of foods and pharmaceuticals in terms of scoville heat units (su). additionally, all those mentioned extracts usually have a red color. It is a valuable characteristic that is measured by manufactures in color units (cu).

The most potent and important chemical substances in capsicum fruits or extracts obtained thereof are capsaicin and dihydrocapsaicin. They contribute mainly in the degree of pungency. Derivatives of capsaicin and itself collectively known as capsaicinoids are found in amounts between 0.1% and 1% in capsicum fruits.

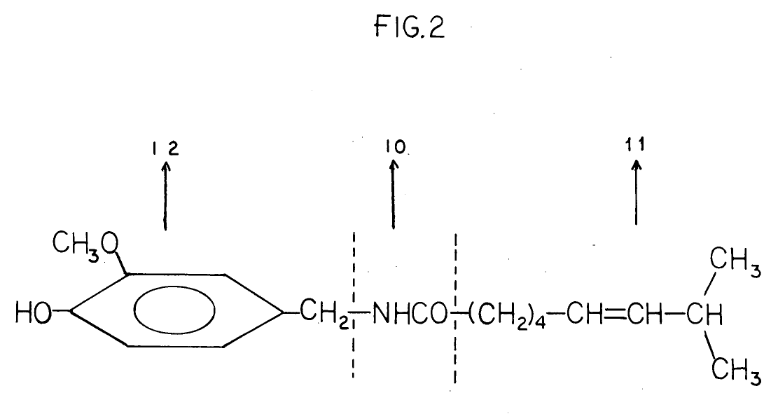

Szolcsanyi et al. (1975), p. 1878, defined three fundamental parts of the capsaicin molecular structure: an acyl-amide link (10), an alkyl chain (11) and an aromatic ring or phenolic group (12) (see FIG. 2).

Capsaicin and capsaicinoids may be classified as acid amide derivatives of a phenol. An addition of a methoxy group (och₃) to this phenol, it forms ortho-methoxyphenyl. In addition, a mehylene group (ch₂) in the para position to ortho-methoxyphenyl, it produces vanillyl.

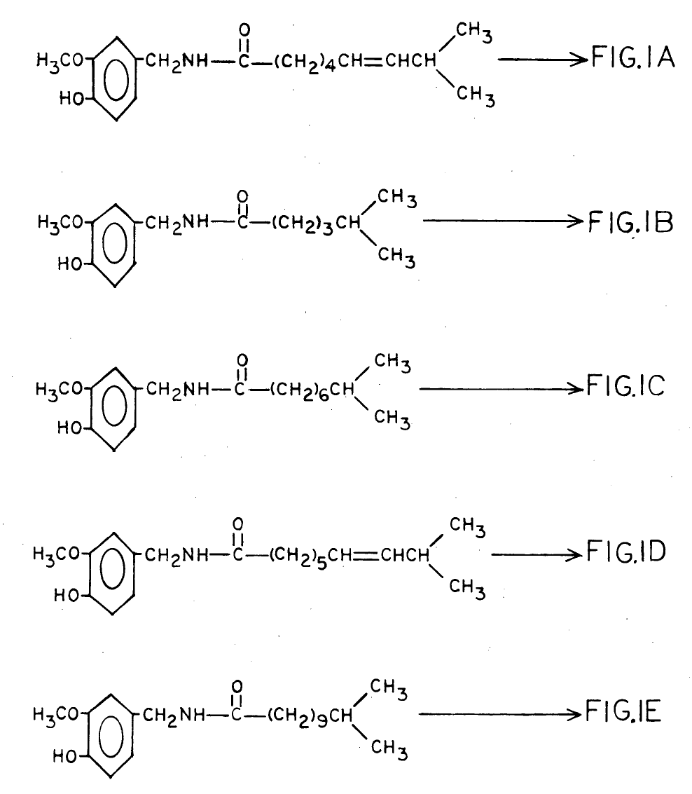

In FIGS. 1 and 2 it is observed that the alkyl chain (11) being not a straight chain acid contains nine carbon atoms as for capsaicin and as for dihydrocapsaicin.

According to Tachibana and Gruber (1988), p. 852, the shark repellent property of pardaxin and mosesin from pardachirus marmoratus is hypothetically due to such surfactants interacting at their hydrophobic alkyl chains surfaces to form a complex, which it reaches a receptor site of a shark's target sense organ. Ultramicroscopic studies revealed that gill chloride cells served as a primary target for a histopathologic action of pardaxin inhibiting it atpase activity (primor et al, 1980, p. 41).

Gruber and Zlotkin (1982) p. 23, researched shark repellent properties of eight (8) surfactants concluding that sodium dodecyl sulfate and lyophilized crude secretion of P. marmoratus strongly repelled sharks. They also concluded that sodium dodecyl sulfate was more effective at repelling captive lemon sharks than the reconstituted lyophilized crude secretion of P. marmoratus.

Sisneros and Nelson (2001) pp. 1117-129, in the article, surfactants as chemical shark repellents: past, present, and future, demonstrated that surfactants with an alkyl sulfate carbon chain showed shark irritant efficacy. In such experiments, surfactants such as sodium octyl sulfate, sodium decyl sulfate, sodium dodecyl sulfate, sodium tetradecyl sulfate, sodium octadecyl sulfate, sodium dodecyl ether sulfate and magnesium dodecyl sulfate revealed efficiency to repel sharks as the carbon chain increased. According to such researchers, the property of hydrophobicity is proportional to carbon chain length.

The alkyl chain (11) of capsaicin can react in a hostile way on buccal and gill epithelia of sharks. Likewise, molecular structure of capsaicin and dihydrocapsaicin has the mentioned ortho-methoxyphenyl group contributing in reactivity as it does the alkyl chain (11). The methoxy group attached to the phenol group (12) increases aromacy and decreases toxicity in the substances. Otherwise pure phenol could be highly corrosive, caustic and toxic.

Mode of Action

OC causes an irritation in cellular pain receptors located on skin and mucous membranes in humans and animals at determined concentrations. Those receptors release substance p(sp), a neurotransmitter that comunicates any pain to the brain. It has been demonstrated that irritant action of capsaicin is mediated by sensory nerves throughout the animal kingdom.

Although chemical oils of OC can stimulate sense of olfaction in sharks, capsaicin is an odorless substance, probably unable to stimulate, specific receptors of this sense. Nevertheless, according to tester (1963), p. 277, fishes have an ability to perceive substances of an irritating nature through receptors. This is separated and distinct from the senses of smell and taste. Such irritant receptors are non-medullated nerve fibre endings or also called free nerve endings. They terminate amongst the epithelial cells and they occur in oral and nasal cavities in both aquatic and terrestrial animals. In fishes they also occur over all the external body surfaces.

Additionally to its effects upon the nervous system, high solubility and reactivity of capsaicin on fat, oils, and greases is strong evidence that it can react on lipid membranes of gills in fishes repelling marine organisms.

Effect of OC upon Marine Organisms

the U.S. Pat. No. 5,226,380 of Fischer (1993), above mentioned incorporates OC in paint for boat hulls. Likewise, it does in submerged pipes. it mentions that the heat generated by OC when mixed with an ablative paint creates a hostile environment to marine organisms without creating a toxic condition in the water surrounding the surface. this invention, also mentions that other Capsicum species as cayenne pepper repels living organisms such as: barnacles, zebra mussels, and other marine organisms.

Research of Cope et al. (1997), pp. 1930-1934, titled, efficacy of candidate chemicals for preventing attachment of zebra mussels (Dreissena polymorpha), reveals with bigger precision the capsaicin effect on marine organisms. it has an ability to modify the behavior of aquatic living organisms such as, zebra mussels. concentrations between 3.6 and 6.1 mcg/ml of capsaicin caused the ability of zebra mussels (5-8 mm shell length) to detach from a substrate. Notwithstanding, this experiment also demonstrated that a toxicity of two candidate chemicals (butylated hydroxyanisole and tannic acid), with phenolic antioxidants characteristics such as capsaicin was substantially greater for fishes such as rainbow trout, blugill and channel catfish than for zebra mussel.

### Preparation and Operation of the Preferred Embodiments

The following three (3) forms for using OC are herein defined:
1. Maintaining close to the user a permissible maximum concentration of oc without complete dilution of it in water to keep an effective deterrent force against sharks or other dangerous aquatic animals (for swimmers and scuba divers).
2. Blending OC with paint as coating (for the johnson shark screen device and other devices to be used in rescue operations).
3. Blending OC with a diluent for using as a spray from against an imminent shark's attack underwater.
   Embodiment Number One
   Solubility

Capsaicinoids contained in OC are not very soluble in water, but they are very soluble in alcohol, grease and oil. They show an amphiphilic characteristic instead of an absolute hydrophobic property. Existence of the phenol group (12) in the molecular structure makes it sparingly soluble in cold water. On the other hand, existence of the alkyl chain (11) makes it very soluble in fat, greases and oils making it able to react with lipid membranes of fishes. OC is manufactured by two different ways according to the used type of solvent. To produce a fat-soluble oleoresin, dichloroethane, hexane or benzene, are used. To produce a water-soluble oleoresin, acetone or ethanol is the usual solvent.

Power of Dilution

The pungency of capsaicinoids is quantified in terms of su. This value is the dilution at which, pungency can just be detected by a trained taster. Pure capsaicin is assigned a su value of 16×10⁶ ml/g, implying that it can be barely detected at a dilution of sixteen million to one (national institute of justice, 1995, p. 2). OC is obtained from the market at different degree of pungency.

To determine capsaicin content in percent according to su, for manufacturing a OC chemical repellent, the following table can be used:

| CAPSAICIN CONTENT % | SU | |
|---|---|---|
| 3.3 | 0.5 | MILLIONS |
| 6.6 | 1.0 | MILLIONS |
| 10 | 1.5 | MILLIONS |
| 20 | 3.0 | MILLIONS |
| 30 | 4.5 | MILLIONS |
| 40 | 6.0 | MILLIONS |
| 60-70 | 10.0 | MILLIONS |

It has been shown by Sizer et al 1985, p. 282 and mentioned by Green 1989, p. 174 that capsaicin can be detected on the human tongue in concentrations as low as 0.1 mcg/ml. Likewise it also is understood that senses of hearing, olfaction and chemical perception of animals such as sharks have an enormous acuity. Therefore, perception of capsaicin by sharks at 0.1 mcg/ml can be definitely perceived in a stronger way than humans in an aquatic environment.

Effect of OC in Humans

In this embodiment scuba divers are protected by the scuba suit and oc is not capable to produce any harm to the skin. For swimmers, which wear no protection underwater, an OC probable effect is here analized.

In humans, OC is barely detected at a concentration of 0.1 mcg/ml. This concentration is extraordinarily low to cause any harm for humans.

A dilution of one part of capsaicin in one million parts of water 1 mcg/ml (1 ppm) provokes a sensation of perceptible warmth on human tongue. Likewise a dilution of one part of capsaicin in one hundred thousands parts of water 10 mcg/ml (10 ppm) provokes a sensation of persistent burning on tongue (Nelson E. K, 1910, p. 420). Limits, ranges and sensation effects of capsaicin vary according to a factor of 10, according to the parameters postulated by nelson.

Rubbing or friction by 10 min a variety of chilies such as pepperoncini containing pungency between 10-100 su and capsaicin concentration between 1-6 ppm, it produces no effect or irritation on the skin. on the other hand, rubbing a variety such as jalapeno by short time too, containing it 2,500-5,000 su and capsaicin concentration between 156-312 ppm, it produces a light irritation on the skin, close to a sensation of perceptible warmth.

After prolonged capsaicin exposure and absorption for the skin by using patches, it produces in humans at subcutaneous and intramuscular level a sensation of perceptible warmth at 10 mcg/ml (10 ppm) and a sensation of persistent burning at 100 mcg/ml (100 ppm). Topical analgesic cream as zostrix (supplied by Gen Derm Corporation) contains capsaicin concentration at 0.025% w/w (250 ppm) in a petrolatum containing cream. This medication is manufactured to produce a non-risky burning effect as therapy on the skin after prolonged exposure.

Culp et al. 1989, experimented heat and mechanical hyperalgesia induced by capsaicin at eight different concentrations showing color picture of skin linear reaction and telethermographic measurement of increased local skin temperature induced by capsaicin. Lower concentrations of capsaicin at 6.6×10⁻⁵ m (20 ppm) and 2×10⁻⁴ m (60 ppm) after three hours following application to forearm caused no flare and irritation on the skin. Above those concentrations can be observed an increase of a flare response.

Additionally to the time of exposure, environment temperature is a conditioning factor of capsaicin skin reaction. Szolcsanyi in 1976 expressed in the article relationship between the effects of capsaicin on heat and pain sensation that, burning pain and hyperaesthesia elicited by painting the skin of the backhand with a 1% (10000 ppm) alcoholic solution of capsaicin cease completely at skin temperatures below 28 deg C. (82.4 deg F.). This cooling effect that is provoked in human skin can be caused by water temperature. Capsaicin and OC are not directly affected by temperature changes and such substances remain potentially active at any temperature changes (see stability in this invention).

The ocean temperature varies horizontally, vertically, and with time. According to a thermal zonality of the global-scale horizontal distribution of the temperature, a surface water temperature is highest in the tropics and decreases toward poleward. From the equator toward the poles, the sea surface temperature (sst) ranges from 30 deg C. (86 deg F.) down to −1.8 deg C. (28.8 deg F.), a freezing point. Thus, sensibility of capsaicin on the human skin is almost totally reduced by the cooling effect of the local temperature of sst, no matter the incidence of factors such as capsaicin concentration and exposure time.

Characteristic of the Embodiment

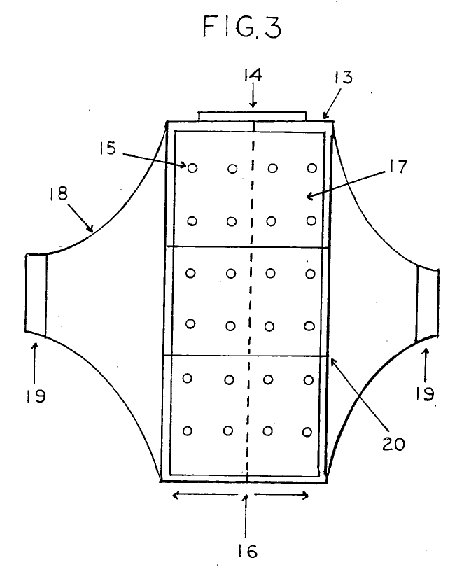

FIG. 3 shows a plastic transparent cylinder (13), between 4 to 8 inches high, and 1 to 2 inches in diameter, which it serves as a container of the active principle to repel sharks (oc). On the top of this cylinder (13), a cap (14) is used to open and close the device. It will serve for filling and refilling the cylinder with oc. Over the frontal face of the cylinder (13) twenty four alined holes (15) in four rows of six from the top to the bottom, 4-6 mm of diameter are located. A solid plastic screen (16) turning by circular way, it closes or discloses such holes, complete or partially. A sponge (17) is introduced inside the device, which is saturated or impregnated with a maximum amount of oc. The complete device is held to a plastic belt (18), with velcros (19) and plastic ties (20). The device is worn around the ankle.

The plastic transparent cylinder (13) of this embodiment shown_in FIG. 3 can be filled or refilled by using a non-diluted water-soluble red color OC ranging between 13% and 26% capsaicin concentration and pungency rating between 2,000,000 and 4,000,000 su. Viscous condition of oc will not allow a rapid dilution of the substance. In this device the sponge (17) is introduced inside the cylinder (13), being taken into account according to different shapes (cylindrical, laminated, or granulated). Likewise this sponge (17) must settle down slightly adjusted inside the cylinder (13) to permit sea water to enter freely into it.

Once holes (15) are disclosed, OC will get out from the cylinder (13) by diffusion mechanisms. The screen (16) is able to close 6, 12, 18, or 24 holes, by turning it. Thus, it is possible to regulate the speed of diffusion. Moreover by opening and closing this screen (16), it permits a continuous or intermittent release of the chemical deterrent. Motion of the diver's ankle will let a mixing of OC with water inside the cylinder (13) and drops of OC sprinkle outside. The plastic belt (18) provides a holding of the device. Nevertheless another function of the plastic belt (18) is for protecting human skin to avoid direct contact with oc. Red color of OC will serve as indicatory signal of presence or absence of oc. Thus, a great quantity of oc is maintained close to the swimmer or scuba diver repelling sharks.

Embodiment Number Two

This embodiment is developed considering acute senses and reflexes of sharks, which it makes to them to retreat instantly to chemicals. An effective chemical repellent is able to stop a shark's bite, a fraction of second at a really short distance measured in centimeters, if a fish, prey or object hold such chemical repellent. In some way, it has been demonstrated by clark (1974), p. 718, with the toxic peptide secreted from pardachirus marmoratus and the read sea's sharproof fish.

Stability

Capsaicin is a stable alkaloid, seemingly unaffected by cold or heat, which it retains its original potency despite time, cooking, or freezing (Dewitt, 1999, p. 56). Capsaicin is very stable toward alkalis (Nelson, 1920, p. 597). Its pungency is not destroyed by heating with 2% NaOh (Monsereenusorn, 1982, p. 321). On the other hand, OC is a sterile product that can remain stable for up to 2 or 3 years under storage conditions. Characteristic of stability makes oc, suitable for coating the shark screen.

Characteristics of the Shark Screen

The shark screen recommended in this invention is the one designed in the U.S. Pat. No. 3,986,220. This has been improved in relation to the former proposed on 1969 by the same inventor in the U.S. Pat. No. 3,428,978. A reduced size and weight are some of the its advantages. A thin film material having the properties of polyethylene terephthalate (pet) commercially named mylar is compactly stored in a small package by vacuum packaging techniques.

The inferior sheet (24) outside, which remains underwater, is coated with OC mixed to a black waterproof immersible paint (25). The inferior sheet (24) may have up to 76 inches in length, but its size is modified in this invention. The bag has no ridges or protuberances and the annular collar (21) has a double wall thickness with an internal annular chamber. A valve (29) allows the collar (21) to be inflated by the disaster victim. A short sleeve (22) is bonded onto the upper edge of the annular collar (21), which is provided with eyelets. A drawstring (23) is strung through the eyelets. When the drawstring (23) is pulled tight, the victim is hidden from view and keeps more heat (27) inside.

The bag prevents any body fluids from leaking into the surrounding water keeping fluids and initial water inside. It will produce no attraction to sharks by producing a heat and pungency effect (30) and permit a rise in temperature of the water to avoiding hypothermia.

Polyethylene Terephthalate and Aluminizing Layer

pet is a plastic resin of the polyester family, used to make beverage, food, liquid containers and aluminized applications. It was patented in 1941 by calico printer's association and developed by dupont in the mid-1950s. mylar has been used for insulation for houses and tents in a cold environment facing inward to reflect body heat back into the houses or tents. Mylar emergency blankets used to reflect body heat back to the patients and mylar spacesuits to keep astronauts warm are other applications. It can be fabricated as an amorphous (transparent) and as a semi-crystalline (opaque and white) material.

This material can be aluminized by the fabricator, alowing reflection of up to 99% of light (28) and heat (27). The bag must be constructed by setting up the aluminizing layer (26) facing inward to the body in its inferior sheet (24) and extending it facing outward on the top. The aluminizing layer (26) will have two different uses. The one facing inside, for reflecting heat (27) back to the body and the another facing outside on the annular chamber (21), for reflecting light (28) as radar reflector.

Mylar has high tensile strength, chemical and dimensional stability and does not tear easily. Mylar thickness ranges between 0.0007 mm and 0.3 mm. It is recommended for construction of the shark screen, 0.008 to 0.010 mm thickness. As it will be explained below the bag is reduced in size and volume for heating efficiency. Due to that coating the bag increase a thickness of it and bag is reduced in size, the cigarette package bag size is maintained equal as designed for the original inventor.

Radar reflector feature of the shark screen makes it possible for manufacturing two types of shark screen:
1. A shark screen for military proposal with aluminizing layer on top for peacetime and without it for wartime to avoid a victim being found by the opposite forces.
2. A shark screen for comercial and civilian proposal with aluminizing layer on top for anytime.
   Characteristic of the Embodiment

This embodiment is designed by blending OC with paint for devices used in rescue operations such as the shark screen, the ifd, flotation bags and lifeboats. It consists of coating the plastic bag by using a paint containing oc (25), which is applied in its external side.

The shark screen was designed from its origin to avoid scents and moving images of a victim. Moreover, the bag helps to keep body heat and give him psychological comfort of being covered. The ifd which is suitable for infants, meets requirements of buoyancy, stability and thermal insulation and can be improved by coating with oc. Likewise, lifeboats and also flotation bags used by nasa to support vehicles with instrumentation on their return from outer space can be coated as well.

Fabrication of a coating is considered by using water based paint as first layer and a waterproof immersible paint mixed with OC as second layer. The first layer will avoid that solvents of the second layer damage the plastic mylar. For the second layer 5-15% of an epoxy-polyamide, polyurethane or another ablative paint may used, which is blended to a 60-80% of liposoluble OC containing between 10% and 30% or more capsaicin concentration and pungency rating between 1,500,000 and 4,500,000 su. A 5% or less of a solvent as xylene or mineral spirit to thin the paint and 5-10% of a solvent as dichloroethane, benzene or hexane to thin OC may be used.

A example to formulate a coating is given as it follows:
first layer
100% water based paint and water as diluent
second layer
80% liposoluble OC 30% capsaicin concentration 4.5 millions su, with a final capsaicin concentration of 24%
8% hexane to thin oc
10% polyurethane to partially seal the whole coating
2% xylene to thin polyurethane

OC water-soluble might also be used. After the first layer is applied, spraying between a 40% and 60% the surface of the bag with the waterproof paint coats a second and partial. Then, while the paint is wet OC water-soluble can be sprinkled or blown on the surface or applied in any other suitable manner. An objective of this embodiment would be a creation of a partial, sticky cover of OC molecules and simultaneously a partial, detached water-soluble OC surrounding the bag.

For visualizing a power of the aforementioned formulation, 24% of the final capsaicin concentration contained in the coating is 14 times more concentrated than counter assault, which it has been used to repel bears. In addition, capsaicin and dihydrocapsaicin are not the only pungent agents found in oc. Several other substances with different degrees of pungency are found in oc, contributing all those substances to the oc deterrent power. Until now, just 20 of 100 chemical compounds have been identified in oc. When it is used 80% OC with 30% capsaicin concentration, a 50% of the remainder is composed by other chemicals.

Preparation of Mylar for Paint

one of the mylar sides is microscopically smooth (the aluminizing side), while the another side contains microscopic asperities which promote adhesion for coating and printing media. Techniques such as brushing, dip coating, flow coating, curtain coating, including all the variations of sraying and rotary atomization, are used to coat plastics.

Low polarity of molecules in plastics such as polyethylene and polypropylene is the cause of a low surface energy and poor paintability of these plastics. It points out toward a procedure for pretreating plastics before painting.

A procedure to pretreat plastics is given as it follows:
1. Plastics are ineffective electrical conductors. As a result of that, they have tendency to build up static charges that attract particles of lint and dust. It requires a destaticizing air blow—off. Positive and negative ions of the destaticizer neutralize static charges.
2. To achieve a robust paint adhesion, it may be necessary to create polar oxidized groups on the surface. It is especially true for low polar plastics, which may be briefly exposed to an open flame from a gas burner. Low polarity plastics can also be surface oxidized using an electrical corona that discharge ozone; by light sensitive chemicals called photosensitizers, followed by ultraviolet light; and by cold gas plasma technology.
   Hypothermia and the Shark Screen

water at low temperature is a dangerous factor, which it might provoke that a disaster victim dies, perhaps before a shark attack is coming. Hypothermia is generally defined as a core temperature of less than 35 deg C. (95 deg F.). Core temperature in the range 34 deg C. to 35 deg C. (93.2 deg F. to 95 deg F.) are considered mildly hypothermic; 30 deg C. to 34 deg C. (86 deg F. to 93.2 deg F.) moderately hypothermic; and less than 30 deg C. (86 deg F.), severely hypothermic.

An average human survival time in cool waters without protection has been calculated according to water temperature, and following data:

| WATER TEMPERATURE (DEG C.) | SURVIVAL TIME (HOURS) |
|---|---|
| 5 (41 DEG F.) | 1-2 |
| 10 (50 DEG F.) | 2-3 |
| 15 (59 DEG F.) | 4-5 |
| 20 (68 DEG F.) | 12 |

shark screen water volume, body heat loss and exposure time are important factors to determine survival time of a disaster victim, which depends exclusively of a tool such as the shark screen. This antishark tool is able to retain seawater, and the victim inside is able to heat it up. Body heat loss can be measured in agreement to a basal metabolic rate (bmr). This is a measure determined under basal conditions at which the quiet, resting, and fasting body breaks down nutrients to liberate energy. It is usually measured indirectly through oxygen consumption, and it is expressed in kilocalories (kcal) per square meter of body area per hour. Uptake of 1 liter of oxygen indicates about 4.9 kcal of heat produced. The oxygen consumption in an hour would be 14 liters. Bmr, would be 68.6 kcal/hour (roughly 70 kcal/hour), and 35 kcal/hour/square meter.

Bodies can lose heat by a variety of mechanisms, the most significant of which, under dry conditions are:
radiation (55-65% of heat loss)*
conduction and convection (15% of heat loss)*
respiration and evaporation (25% of heat loss)

according to aforementioned data 75% of bmr* could be directed to heat up the retained water of the shark screen. It results at 52.5 kcal/hour.

Estimated measures for the shark screen are designed to keep a minimal quantity of water for maximal efficiency of heating by bmr. Thus, two types of shark screen are here manufactured considering the risks of hypothermia.

A standard shark screen for summertime and a shark screen for wintertime is constructed. They have different dimensions according to the following data:
Standard shark screen (for summertime):
Diameter on top 24 inches minimum=60 cms for trunk covering.
Length 60 inches minimum=150 cms for body covering.
Annular collar diameter 6 inches minimum=15 cms for head covering.
Volume=0.141 cubic meters (141 liters of contained water).
Mylar thickness=0.008 mm
Water minimal temperature permissible for using=23 deg C. (73 deg F.)
Shark screen for wintertime:
Diameter on top 24 inches minimum=60 cms for trunk covering.
Length 32 inches minimum=80 cms in a crouch position for body covering
Annular collar diameter 6 inches minimum=15 cms for head covering
Volume=0.074 cubic meters (74 liters of contained water)
Mylar thickness=0.010 mm (thicker than the standard model).
Water minimal temperature permissible for using=16 deg C. (61 deg F.)

The content and produced heat from the body (27) can be measured in kcal. One (1) kcal is the quantity of heat which is needed to increase the temperature of one (1) kg of water from 15 to 16 deg C. Herein, is calculated an increase in temperature generated inside of the shark screen, which may be defined according to the next following equation:
wt_{inc}=bmr×t/ssww

where: wt_{inc}=water temperature increase in deg C.; bmr=basal metabolic rate in kcal/hour; t=time in hours; ssww=shark screen water kg.

As the water density at 4 deg C. is equal to one (1) gram per cubic centimeter, shark screen volume in liters is equal to its weight in kg. roughly, 10 hours remaining into the water a disaster victim can theoretically produce 525 kcal (10 hours×52.5 kcal/hour). This amount of heat (27) is able to increase, 7 deg C. (44.6 deg F.) a water mass of 74 liters in 10 hours and 14 deg C. (57.2 deg F.) in 20 hours, if used shark screen for wintertime. During the summer, risks by hypothermia are lesser, nevertheless shark screen for the summertime is able to increase the temperature of a mass of water of 141 liters, 7.5 deg C. (45.5 deg F.) in 20 hours. the next following data comprises a temperature increase for both types of shark screen:

| TIME | SHARK SCREEN FOR | STANDARD (SUMMERTIME) |
|---|---|---|
| HOURS | WINTERTIME DEG C. | DEG C. |
| 5 | 3.5 (38.3 DEG F.) | 1.8 (35.2 DEG F.) |
| 10 | 7 (44.6 DEG F.) | 3.7 (38.6 DEG F.) |
| 15 | 10.6 (51 DEG F.) | 5.5 (41.9 DEG F.) |
| 20 | 14.2 (57.5 DEG F.) | 7.5 (45.5 DEG F.) |

heat loss (27) is cumulative because contained water is retained. Heat transfer from the shark screen to the surrounding water is considered minimal because the aluminizing layer (26) of the mylar inside the bag will act reflecting heat (27) back to the body. Absorption of solar radiation, will add heat to the shark screen. Thus, minimal heat loss by thermodynamic transfer is compensated.

Likewise, it is possible to calculate a new water temperature, because the victim caused water heating, according to the following equation:
mwt=wt_{inc}+wtᵢₙᵢₜᵢₐₗ

where: mwt=modified water temperature in deg C.; wt_{inc}=water temperature increase in deg C.; wtᵢₙᵢₜᵢₐₗ=water temperature initial at the moment a disaster happens. By using this new value of mwt is possible to calculate a new human survival time average in agreement with the paragraph [0068].

Minimal temperature for using the shark screen for wintertime is about 16 deg C. (61 dge F.). Without any protection, survival time average is about 5.5 hours at 16 deg C. for this period of time, the shark screen for wintertime is able to retain 288 kcal. Hence, it rises the water temperature of the bag at 19.9 deg C. (67.8 deg F.), changing it the survival time average for 12 hours. 6.5 more hours will retain more heat (341 kcal), rising the water temperature of the shark screen at 24.5 deg C. (76.1 deg F.) prolonging the time of survival. In this case, the bag has been designed with a reduced length, but preserving the rest of original and structural characteristics. A reduced size will contain lower amount of water producing bigger heating efficiency. On the other hand, the victim will keep a sit down position inside of the bag, following a natural tendency of the human being to keep heat and crouch when felt it is a freezing sensation on the skin.

Scenario for the Shark Screen

a scenario may be pictured to determine usefulness of the improved shark screen invention. It is possible to conjecture 3 persons struggling in the middle of the ocean after an airplane crash or shipwreck. Before that happened, they were supplied with three antishark devices:
person no 1. [Using an effective shark chemical repellent bottled in a size cigarrette container]
person no 2. [Using an effective electric or electronic shark repellent device (with ultrasound or another effective technique)]
person no 3. [Using a shark screen with an effective shark repellent coating]

persons no 1 and 2 are capable to deter sharks during a determined period of time. Shorter time will have the person no 1 than the person no 2. Once the container of the shark chemical repellent held for person no 1 is over, that person will swim in troubled circumstances wether sharks get close in surrounding waters. Person no 2 will have probabilities to survive deterring sharks, until acute symptoms of hypothermia arise. Once that, body temperature declines at a dangerous level, person no 2 will die probably by hypothermia effect than by shark attack. Person no 3 will rise the marine water temperature trapped inside of the shark screen, helping it to avoid hypothermia. Simultaneously antishark chemical coating of the bag will repel sharks in surrounding waters. It also may be probable that in this scenario, aforesaid three persons survive by attracting long distance help, which it might occur by effect of the aluminizing layer reflecting light of the shark screen.

Embodiment Number Three

A natural use of OC for repelling terrestrial animals has been done under a spray form. This way to deliver a rapid squirt or atomized blast of oc for repelling dangerous aquatic animals as sharks is proposed in this embodiment. This device must comprise 1. A pressurized can with OC at a high concentration ranging it between 3% and 30% capsaicin concentration and pungency rating between 500,000 and 4,500,000 su. 2. A solvent for diluting oc. 3. A carrier such as co₂ for pressuring the can. 4. A 2 m minimum squirt distance underwater. 5. A minimum required pressure for providing 10 blasts produced by a lateral trigger, and 6. A leash holding the can close to the scuba diver. Such a device is suitable for self-defense, as a shield for repelling sharks by leaving a cloud of oc, between a scuba diver and a shark or for spraying directly to avoid a shark's attack underwater.

A preparation of a solution with 12% capsaicin concentration for this embodiment may be defined as it follows:
40% hydrosoluble OC with 30% capsaicin concentration and 4.5 millions of su
10% hexane as solvent to thin OC
50% filtered water
can pressurized with CO₂
   Extraction and Preparation of OC

OC is commercially available in the food and pharmaceutical market. It is a product extracted from cultivates grown around the world. It also is not expensive and easy to manufacture. Four (4) oleoresin extractions plants are located in the United States and there are additional plants in: Spain, India, South Africa AND Japan.

A process to obtain OC begins by dehydrating pods to 3% moisture. Dehydrated pods are ground to a coarse powder and pelletized. OC is extracted with methanol, which it binds with the capsaicin. The mixture settles and can be drained off, and methanol is distilled. The result is concentrated OC.

It will be apparent to those skilled in the art that modifications can be made without departing from the scope of the present invention. Therefore, it is intended that the invention only be limited by the claims.

What is claimed is:

1. A shark deterrent device manufactured by containing and using a natural extract from plants of the genus of capsicum, comprising:
a. using a natural extract of oleoresin capsicum or also called african capsicum oleoresin, which is extracted from plants of genus of capsicum, and
b. using a capsaicin and derivatives as essential compounds contained in said oleoresin capsicum, which they exhibit a required power of dilution and amphiphilic characteristics, and
c. using a water-soluble and liposoluble extracts of said oleoresin capsicum and a varying capsaicin concentration and pungency rating, and
d. using a pure and viscous extract of said oleoresin capsicum or mixing it with a solvent and a waterproof paint in predetermined devices and embodiments, and
e. using a colorized and decolorized oleoresin capsicum as valuable characteristic for taking advantage of a device to use, and
f. employing said oleoresin capsicum by manufacturing said predetermined devices for swimmers and scuba divers and as a coating to improve protection against sharks in rescue operation devices, and
whereby said capsaicin and derivatives contained in said oleoresin capsicum will exert an action of repelling sharks, and
whereby a alkil chain and an antioxidant phenolic group of said capsaicin and derivatives will exert a hostil reaction on a lipid membrane of gills and on a non-medullated fibre nerves of body suface of said sharks, and
whereby properties of pungency of said capsaicin and derivatives will exert a action for repelling said sharks, wether said oleoresin capsicum is contained in the predetermined devices.

2. A shark deterrent device of claim 1, wherein said oleoresin capsicum contained in a device shown in FIG. 3, is diluted in a sea water maintaining close to the user a permissible maximum concentration without complete dilution of it, and keeping an effective deterrent force against sharks, comprising:
a. a sponge containing said oleoresin capsicum, which it will retain and store the chemical deterrent, and
b. a plastic transparent cylinder, which it will encase said sponge slightly adjusted inside of, and
c. said plastic transparent cylinder will release said oleoresin capsicum through some holes, which are disclosed partial and completely by turning a solid screen, and
d. said plastic transparent cylinder will be held by a plastic belt, which is fastened around an ankle, and
whereby said sea water will get into said plastic transparent cylinder, and said oleoresin capsicum will get out from the cylinder by a diffusing mechanism, and
whereby a motion of said ankle will mix the deterrent with said sea water, sprinkling drops of it outside of the cylinder, and
whereby said oleoresin capsicum being diluted in said sea water by continuous or intermittent way will repel said sharks by irritant mechanisms.

3. A shark deterrent device of claim 2, which is filled and refilled by using a pure and colorized non-diluted water-soluble oleoresin capsicum, containing a capsaicin concentration ranging between 13 and 26%, and pungency rating ranging between 2,000,000 and 4,000,000 scoville heat units.

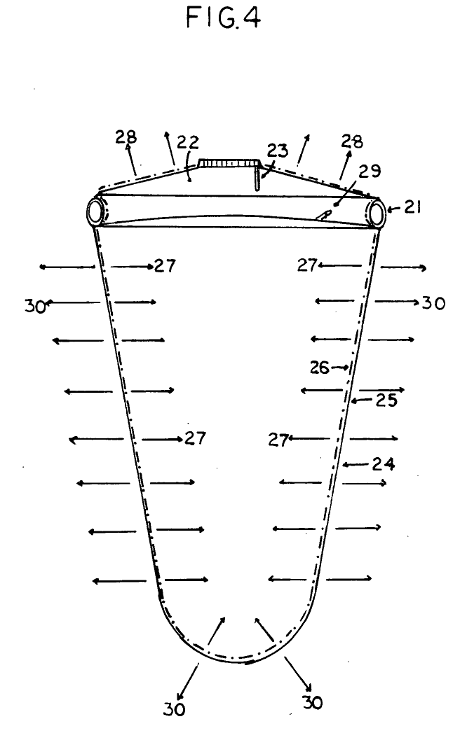

4. A shark deterrent device of claim 1, wherein a rescue operation device called shark screen, is herein improved and shown in the FIG. 4, comprising:
a. coating said shark screen with the anti-shark substance named oleoresin capsicum on an exterior surface, and
b. using an aluminized layer in an interior surface to retain a body heat loss for avoiding a victim of a plane crash or shipwreck dying by a hypothermia in cool waters, and
c. reducing a size and weight of said shark screen to contain a lower volume of the marine water for improving a heating efficiency of the bag and avoiding said victim dying by said hypothermia in cool waters, wherein a minimal and permissible water temperature for using it is around 16 degrees centigrade, and
whereby said coating will generate a sticky, piquant and hostile cover for repelling sharks and other marine creatures, and
whereby said aluminized layer in the interior surface of the bag, and, reduced size, weight and volume will improve said heating efficiency retaining said body heat loss from the victim.

5. A shark deterrent device of claim 4, wherein said coating is manufactured by using said oleoresin capsicum containing a capsaicin concentration between 10 and 30% and using a pungency rating between 1,500,000 and 4,500,000 scoville heat units.

6. A shark deterrent device of claim 4, wherein a first layer in said coating is manufactured by using a water based paint to protect a mylar plastic material against solvents.

7. A shark deterrent device of claim 4, wherein a second layer in said coating is manufactured by blending said oleoresin capsicum and said waterproof paint, comprising:
a. a 5-15% of the waterproof immersible paint such as an epoxy-polyamide, polyurethane or another ablative paint, and
b. a 80% of said liposoluble or water-soluble oleoresin capsicum, and
c. a 10% of a solvent such as hexane, benzene or dicloroethane to thin said oleoresin capsicum, and
d. a 5% and less of a solvent as xylene to thin said waterproof immersible paint.

8. A shark deterrent device of claim 7, wherein said liposoluble oleoresin capsicum is blended to the waterproof paint before painting, and said water-soluble oleoresin capsicum is sprinkled or blown after the waterproof paint is partially applied to a 40-60% of the shark screen surface.

9. A shark deterrent device of claim 1, which is squirted underwater by applying a blast spray form to avoid a shark's attack, comprising:
a. a pressurized can using a high concentration of said oleoresin capsicum wherein said capsaicin concentration ranging between 3 and 30% and pungency rating between 500,000 and 4,500,000 scoville heat units, and
b. using a solvent for diluting said oleoresin capsicum, and
c. using a carrier such as a carbon dioxide for pressuring the can, and
d. performing a 2 meters minimum squirt distance underwater, and
e. manufacturing the device with a minimum required pressure for providing 10 blasts produced by a lateral trigger, and
f. having a leash to hold the can close to the scuba diver.
